(19) United States
(12) Patent Application Publication
(10) Pub. No.: US 2005/0037229 A1
(43) Pub. Date: Feb. 17, 2005

(54) Plated material, method of producing same, and electrical / electronic part using same

(76) Inventor: Hitoshi Tanaka, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/871,637

(22) Filed: Jun. 17, 2004

Related U.S. Application Data
(63) Continuation-in-part of application No. 10/247,319, filed on Sep. 18, 2002, now Pat. No. 6,770,383.
Application No. 10/247,319 is a continuation of application No. PCT/JP02/00279, filed on Jan. 17, 2002.

(30) Foreign Application Priority Data
Jan. 19, 2001 (JP) 2001-11854
Sep. 28, 2001 (JP) 2001/303734

(51) Int. Cl. B32B 15/20

(52) U.S. Cl. 428/647; 428/929; 439/886; 428/648; 148/537; 428/941; 427/383.1

(57) ABSTRACT

A method of producing a plated material having both high heat-resistance and good insertability/extractability. An undercoating of any one of metals belonging to group 4, group 5, group 6, group 7, group 8, group 9 or group 10 of the periodic table or an alloy containing any one of those metals as a main component, an intermediate coating of Cu or a Cu alloy, and a top-coating of Sn or an Sn alloy are formed on a surface of an electrically conductive base in this order. Then, for example by heat treatment, the intermediate coating is made to disappear and a layer virtually made of an Sn—Cu intermetallic compound is formed.

### TECHNICAL FIELD

The present invention relates to a plated material, a method of producing the plated material, and an electrical/electronic part using the plated material. More specifically, the present invention relates to a plated material that has high heat-resistance and is suited to be a material for a connector used in a high temperature environment such as an engine room of an automobile. Further, the present invention relates to a plated material that has both high heat-resistance and good insertability/extractability, so that it is suited to be a material for a fitting-type connector or contactor used in a high temperature environment.

### Prior Art

A plated material comprising an electrically conductive base of Cu or Cu alloy and a coating of Sn or Sn alloy formed on the base is known as a high-performance electrical conductor having high electrical conductivity and high strength of the base as well as good electric-contact property, high corrosion-resistance and good solderability of Sn or Sn alloy. The plated material of this type is used widely for various terminals, connectors, etc.

As the plated material of this type, usually a material that is produced by forming an undercoating of Cu or Ni on a base and then forming a coating of Sn or Sn alloy directly on the undercoating is used. The undercoating is provided to restrain a component of the base (component of alloy such as Cu or Zn) from diffusing into the top-coating of Sn or Sn alloy. Especially when the undercoating is a coating of Ni or Ni alloy, it is highly effective in retarding the above-mentioned diffusion into the top-coating of Sn or Sn alloy even in a high temperature environment. As a result, the properties of Sn or Sn alloy of the top-coating are maintained for a long time.

However, even the above-described plated material having an undercoating of Ni or Ni alloy has a problem. That is, when the plated material is used at a place where the temperature becomes very high, for example, near an engine in an engine room of an automobile, Cu of the base and Ni or Ni alloy of the undercoating still diffuse toward the top-coating with time. After a certain time has passed, the top-coating is no longer the original coating of Sn or Sn alloy, that is, the top-coating of Sn or Sn alloy practically disappears. As a result, the plated material does not exhibit its original performance.

The problem like this can be solved by making the thickness of the top-coating of Sn or Sn alloy larger so that it may take longer time for the top-coating to disappear. However, the solution like this leads to waste of resources. In addition, it may cause another problem. That is, in the case where the plated material is used for, for example, a connector where many terminals are fitted at the same time (a fitting-type connector), the above solution may make it difficult to fit the terminals to a partner member.

In the fitting-type connector, a male terminal is fitted in a female terminal to thereby form electrical connection. In recent years, regarding a connector terminal used in an automobile, transmitted information has been increasing and electronic control performance has been developing. With this, multiplication of connector pins has been proceeding. In that case, if force required for inserting a terminal stays the same, a connector having a larger number of pins needs as much larger force for insertion. Thus, regarding a connector having a large number of connector pins, reduction in the force required for insertion is demanded.

As a terminal that meets this demand, there is, for example, a terminal having a top-coating of Au. When this terminal is used, the force required for insertion reduces. However, Au is expensive, which causes another problem that the cost of producing the terminal is high.

As a connector terminal, a terminal comprising an electrically conductive base of, for example, Cu and an Sn coating formed on the surface of the base is generally used. In the case of this terminal, since Sn is a material that is easily oxidized, a hard skin layer of Sn oxide is always formed on the surface of the terminal when the terminal is in the atmosphere.

When this terminal is inserted, the hard skin layer of Sn oxide breaks at the time the terminal fits in a partner member. As a result, the non-oxidized Sn coating under the hard skin layer of Sn oxide comes in contact with the partner member, so that electrical connection is formed between both. However, if the formed Sn coating is thin, the whole Sn coating turns into an Sn oxide layer and the Sn oxide layer does not easily break when the terminal fits in the partner member. In addition, in the case where the base is of Cu or Cu alloy, Sn of the thin Sn top-coating reacts with a component of the base in practical use in a high temperature environment, so that Cu is exposed at the surface and a layer of Cu oxide is formed on the surface. As a result, reliability of contact with the partner member is lost.

The probability that the problem as above happens can be reduced by making the Sn top-coating thicker. However, this causes another problem that larger force for insertion is required when the terminal is fitted to the partner member.

Thus, there is a problem that particularly in a high temperature environment, there is no choice but to use an expensive Au-plated terminal or an Sn-plated terminal having a thick Sn top-coating and a small number of pins.

When a coating of Sn or Sn alloy is formed on the surface of a terminal, bright Sn plating or reflow Sn plating is applied generally.

In the case of a coating formed by bright Sn plating, the coating contains a large amount of additives used in plating. In addition, the grain size of Sn crystal in the coating is fine. Therefore, the surface of the coating has good lubricity, and the amount of the coating scraped off at the time of fitting or sliding is small. Thus, the coating has good insertability/extractability. However, because of the fine grain size, when the material with this coating is used in a high temperature environment, the rate of grain-boundary diffusion of a component of the base is high, so that the component of the base may diffuse up to the surface of the terminal. Thus, the material with the coating formed by bright Sn plating has low heat-resistance.

In reflow Sn plating, after plating of the entire surface is finished, the top-coating is heated and fused. As a result, in the top-coating formed by reflow Sn plating, Sn has a large grain size, and the additives that had come into the coating during plating have been removed. Therefore, even in a high temperature environment, the rate of grain-boundary diffusion of a component of the base is low. Thus, the material with the coating formed by reflow Sn plating has high heat-resistance. However, because of the large grain size, the amount of the coating scraped off at the time of fitting or sliding is large. In addition, since the amount of additives contained in the coating is small, the coating is worse in lubricity, and therefore worse in insertability/extractability.

In this situation, various methods have been proposed for improving heat-resistance and insertability/extractability of the Sn coating.

For example, Japanese Unexamined Patent Publication No. Hei 8-7940 and Japanese Unexamined Patent Publication No. Hei 4-329891 disclose methods in which a coating of a metal having a high melting point, especially of Ni is formed as an undercoating for an Sn coating so as to improve heat-resistance. In the case of these methods, in the temperature range of about 100-120° C., the Ni coating restrains reaction between a component of the base (component of an alloy such as Cu, Zn or the like) and Sn of the Sn coating. In addition, the rate of reaction between Ni and Sn is low. Therefore, the heat-resistance effect is obtained. However, in a high temperature environment of 140° C. or higher, the rate of reaction between Ni and Sn becomes higher, and the quality of the Sn top-coating changes. As a result, the heat-resistance effect is not obtained. Even in environment of 120° C., after long period of more than 1000 hours, quality of the Sn top-coating changes as described above.

Japanese Unexamined Patent Publication No. Hei 11-121075 and Japanese Unexamined Patent Publication No. Hei 10-302864 disclose methods in which the thickness of an Sn top-coating is made small so as to improve insertability/extractability.

In the case of the Sn top-coating formed by these methods, the amount of the top-coating scraped off at the time of fitting or sliding is smaller, and insertability/extractability is better. However, since the thickness of the Sn coating is small, only with a little heating, the Sn top-coating turns into an alloy by a component of the base diffusing in it, and therefore disappears. This leads to increase in contact-resistance between a terminal and its partner member.

U.S. Pat. No. 6,083,633 discloses an electrical conductor in which a Cu-based first constituent layer and a transition-metal-based second constituent layer are formed on the surface of a Cu base in this order to form a barrier layer and an Sn coating is formed on this barrier layer.

In this conductor, the thickness of the first constituent layer and the thickness of the Sn coating are specified to satisfy a predetermined relationship to thereby ensure the heat resistance of the Sn top-coating.

However, in the case of this conductor, when reflow treatment is performed after the Sn coating is formed in order to prevent whiskers from growing on the Sn top-coating, Sn and Cu mutually fully diffuse into the first constituent layer and the Sn coating almost over their specified thicknesses and turn into an alloy.

In other words, in the case of this conductor, the Sn top-coating disappears directly after reflow treatment, so that the insertability/extractability deteriorates.

As stated above, with the conventional plated materials having an Sn top-coating, there is a problem that it is very difficult to ensure both heat-resistance and insertability/extractability.

### DISCLOSURE OF THE INVENTION

An object of the present invention is to provide a plated material having a top-coating of Sn or Sn alloy which is designed to ensure that even in a high temperature environment, the rate of diffusion reaction between the top-coating and a base or an undercoating is low so that the plated material may have high heat-resistance, and also provide a plated material which has both high heat-resistance and good insertability/extractability and is suited to be a material for a fitting-type connector or contactor used in a high temperature environment.

Another object of the present invention is to provide a method of producing the above-mentioned plated material, and to provide an electrical/electric part, for example, a fitting-type connector or contactor using the above-mentioned plated material.

In order to attain the above objects, the present invention provides
a method of producing a plated material, comprising the steps of:
forming an undercoating of any one of metals belonging to group 4, group 5, group 6, group 7, group 8, group 9 or group 10 of the periodic table or an alloy containing any one of those metals as a main component, an intermediate coating of Cu or a Cu alloy, and a top-coating of Sn or an Sn alloy on a surface of an electrically conductive base in this order, and making the intermediate coating disappear and forming a layer virtually made of an Sn—Cu intermetallic compound.

Further, the present invention provides electrical/electronic parts, more specifically, a fitting-type connector, a contactor, etc. using a plated material produced by the above method.

### BRIEF DESCRIPTION OF THE DRAWINGS

FIG. 1 is a cross-sectional view of a layer structure of an example of a plated material before the intermediate coating of which is made to disappear;

FIG. 2 is a cross-sectional view showing a layer structure of a plated material which is performed to make the intermediate coating of the plated material of FIG. 1 to disappear and is formed a layer made of an Sn—Cu intermetallic compound;

FIG. 3 is a graph showing a relationship between the thickness (X) of a Cu coating before heat treatment (light temperature environment test) and the thickness of the Sn coating after the high temperature environment test in experiment (1); and

FIG. 4 is a graph showing a relationship between the thickness (X) of a Cu coating before reflow treatment and the thickness of the Sn coating after the reflow treatment in experiment (2).

### BEST MODE OF CARRYING OUT THE INVENTION

A plated material produced by a method according to the present invention has a four-layer structure described later.

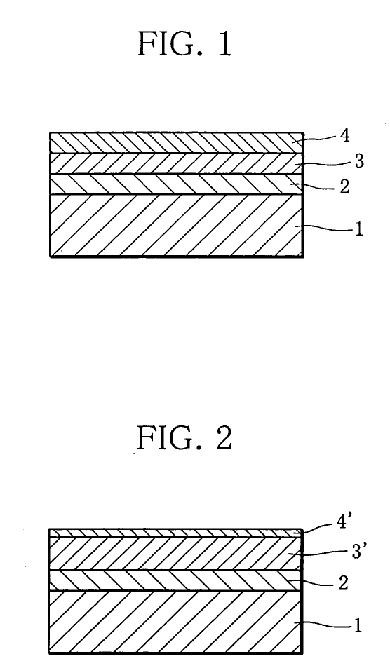

First, as shown in FIG. 1, the plated material having as a whole an undercoating 2, an intermediate coating 3, and a top-coating 4 (each described later) which are formed on an electrically conductive base 1 in this order is made. The material for and thickness of each layer is designed as described later, in order to improve both heat-resistance and insertability/extractability. The most important feature of this plated material is that the intermediate coating 3 exists between the undercoating 2 and the top-coating 4 and performs a function described later, so that disappearance of the top-coating 4 in a high temperature environment is restrained.

The material for the electrically conductive base 1 is not restricted to any special one. For example, in view of being used for a connector, the material for the electrically conductive base 1 may be chosen from among, for example, pure copper; copper alloys such as phosphor bronze, brass, nickel silver, beryllium copper, Corson alloy; pure iron; iron alloys such as stainless steel; various nickel alloys; and composite materials such as Cu-coated Fe material and Ni-coated Fe material, depending on the required mechanical strength, heat-resistance and electrical conductivity, appropriately.

Among the above materials, Cu or Cu alloy is preferable.

In the case where the electrically conductive base 1 is not made of a Cu material, if the surface of the electrically conductive base 1 is plated with Cu or Cu alloy prior to practical use, the adhesiveness and corrosion resistance of a coating formed thereon is further improved.

The undercoating 2 formed on the electrically conductive base 1 is provided in order to ensure the adhesion strength between the base 1 and the top-coating. In addition, the undercoating 2 functions as a barrier layer that prevents thermal diffusion of a component of the base towards the top-coating. Specifically, the undercoating 2 is made of any of periodic table group 4 elements (Ti, Zr, Hf), group 5 elements (V, Nb, Ta), group 6 elements (Cr, Mo, W), group 7 elements (Mn, Tc, Re), group 8 elements (Fe, Ru, Os), group 9 elements (Co, Rh, Ir) and group 10 elements (Ni, Pd, Pt), or an alloy containing any of these elements as a main component.

All the above-mentioned metals are high-melting metals having a melting point of 1000° C. or higher. On the other hand, for example, the temperature of use environment for a connector is generally 200° C. or lower. Therefore, in such use environment, the possibility of thermal diffusion of a component in the undercoating 2 is low. Moreover, the undercoating 2 prevents thermal diffusion of a component of the base toward the top-coating, effectively.

Among the above-mentioned metals, Ni, Co and Fe are preferable because of the cost and ease of plating. As alloys containing any of these metals as a main component, for example, Ni—P, Ni—Sn, Co—P, Ni—Co, Ni—Co—P, Ni—Cu, Ni—Cr, Ni—Zn, Ni—Fe, etc. can be mentioned.

Though the above-described undercoating can be formed by a plating method such as PVD method, it is preferable to apply a wet plating method.

Here, if the main purpose is to improve the heat-resistance of the plated material, it is desirable that the thickness of the undercoating 2 is in the range of 0.05˜2 μm.

This is because if the thickness of the undercoating 2 is too small, the undercoating 2 does not produce the above-mentioned effects sufficiently, and if the thickness of the undercoating 2 is too large, large strain is accumulated in the coating, so that the coating separates from the base 1 easily.

If both improvement in heat-resistance and improvement in insertability/extractability of the plated material are intended, it is useful to make the thickness of the top-coating 4 small. In that case, however, the undercoating 2 needs to produce a greater diffusion-prevention effect. For this purpose, it is desirable that the thickness of the undercoating 2 is 0.25 μm or larger, though it is not restricted to any particular thickness. However, too large a thickness of the undercoating 2 is useless. Moreover, it may cause cracking when the plated material is machined into a terminal. In view of formability, it is desirable that the upper limit of the thickness of the undercoating 2 is in the range of about 0.5˜2 μm.

Next, the intermediate coating 3 formed on the undercoating 2 is made of Cu or Cu alloy. The intermediate coating 3 functions as a layer that prevents inter-diffusion between a component of the undercoating 2 and Sn of the top-coating 4 in a manner described later.

The rate of reaction between Cu of the intermediate coating 3 and Sn of the top-coating 4 is higher than the rate of reaction between Cu of the intermediate coating 3 and a component of the undercoating 2 (the above-mentioned metal or alloy). Therefore, when the plated material is placed in a high temperature environment, thermal diffusion of Sn of the top-coating 4 into the intermediate coating 3 goes on, so that the intermediate coating 3 turns into a layer 3′ of Sn—Cu intermetallic compound as shown in FIG. 2. At the same time, Sn of the top-coating 4 of the plated material moves and diffuses into the intermediate coating 3, starting from the boundary between the top-coating 4 and the intermediate coating 3, and turns into the above-mentioned intermetallic compound. As a result, the coating 4′ of remaining Sn (or Sn alloy) has a smaller thickness. When Cu of the intermediate coating 3 finishes receiving Sn or Sn alloy that diffuses from the top-coating, the inter-diffusion between Sn or Sn alloy and Cu or Cu alloy stops.

As a result, as shown in FIG. 2, the intermediate coating 3 and part of the top-coating 4 shown in FIG. 1 turn into a layer 3′ of an intermetallic compound. The top-coating 4 in FIG. 1 remains as a layer 4′ of Sn or Sn alloy, though its thickness is smaller than before.

The existence of the layer 3′ of an intermetallic compound between the undercoating 2 and the layer 4′ of Sn or Sn alloy restrains reaction between the layer 4′ and the undercoating 2.

Thus, in a high temperature environment, the plated material shown in FIG. 1 is used with the layer structure shown in FIG. 2, that is, in a state that inter-diffusion between Sn or Sn alloy and Cu or Cu alloy is restrained. Therefore, the top-coating of Sn or Sn alloy does not disappear while the plated material is used.

As Sn—Cu intermetallic compound, Cu₆Sn₅ and Cu₃Sn are well known. Cn₆Sn₅ is a compound produced by 1.9 volume Sn reacting with 1 volume Cu. Cn₃Sn is a compound produced by 0.8 volume Sn reacting with 1 volume Cu.

Therefore, if the thickness of the top-coating 4 is 1.9 times or more the thickness of the intermediate coating 3 shown in FIG. 1, the top-coating 4′ of Sn or Sn alloy still remains even if Cu of the intermediate coating 3 all turns into the above-mentioned Sn—Cu intermetallic compound due to the above-mentioned inter-diffusion. Since the Cu of the intermediate coating 3 is fixed as Sn—Cu intermetallic compound, the thermal diffusion of Cu is restrained.

Considering the above, in the plated material shown in FIG. 1, it is desirable to arrange that the thickness of the top-coating 4 is 1.9 times or more the thickness of the intermediate coating 3.

By doing so, it is ensured that the top-coating 4′ of the plated material remains Sn or Sn alloy even in a high temperature environment, which ensures the contact reliability of the plated material.

Here, if the thickness of the intermediate coating 3 is too small, a problem is caused. For example, when the intermediate coating 3 is made of Cu, many fine holes exist in the intermediate coating 3, so that Ni, Cu or another component of the undercoating 2 diffuses through the fine holes in the intermediate coating 3.

If the thickness of the intermediate coating 3 is too large, all the Sn or Sn alloy of the top-coating 4 is consumed in the above-mentioned inter-diffusion unless the thickness of the top-coating 4 is considerably large. As a result, no Sn or Sn alloy remains at the surface of the plated material. If, in order to avoid this, the top-coating 4 is made thick, it leads to a problem that a fitting-type connector using this plated material receives large insertion resistance.

Taking the above problems into consideration, it is desirable that the thickness of the intermediate coating 3 is in the range of 0.01˜1.0 μm.

As the Cu alloy which the intermediate coating 3 is to be made of, for example, Cu—Zn, Cu—Sn, Cu—Ni and Ni—Sn can be mentioned. Here, the Cu content needs to be such that does not hinder the formation of the above-mentioned Cu—Sn intermetallic compound. It may be, for example, 50 mass % or higher.

It is to be noted that in the case of the plated material shown in FIG. 1, it is possible to make the thickness of the top-coating 4 small, keeping the above-mentioned relation in thickness between the intermediate coating 3 and the top-coating 4, that is, keeping the condition that the thickness of the latter is 1.9 times or more the thickness of the former. This makes it possible to improve the insertability/extractability.

For example, if the thickness of the intermediate coating 3 is 0.47 μm or smaller, the plated material has sufficient heat-resistance and at the same time good insertability/extractability even if the thickness of the top-coating is 1 μm or lower. Further, if the thickness of the intermediate coating 3 is 0.26 μm or smaller, the thickness of the top-coating 4 can be made further smaller, such as about 0.6 μm, which is advantageous.

When heat treatment such as reflow treatment is performed on the top coating 4, it is important that the plated material after heat treatment does not produce large friction to its partner member (in other words, the plated material after heat treatment has good insertability/extractability) in its initial state. At the same time, it is important that the plated material after heat treatment maintains low contact resistance even when it is placed in a high temperature environment for a long time (in other words, the plated material after heat treatment has high heat resistance).

These are achieved if, as mentioned above, the already formed intermediate coating (layer of Cu or Cu alloy) 3 turns into a layer 3′ virtually made of an Sn—Cu intermetallic compound and a top-coating (layer of Sn or sn alloy) 4 of an appropriate thickness remains on it even when the produced plated material is placed in a high-temperature environment as mentioned above.

For this, it is necessary to determine the thickness of the intermediate coating 3 (expressed as X μm) and the thickness of the top-coating 4 (expressed as Y μm) appropriately when plating is performed.

In the plated material according to the present invention, the X value and the Y value are determined on the basis of the results of experiments described later, in the manner described below.

The X value and the Y value are determined to satisfy the requirements below:

Requirement A: This is the requirement for Sn of the top-coating 4 remaining even when heat treatment causes reaction between Cu of the intermediate coating 3 and Sn of the top-coating 4 to produce an Sn—Cu intermetallic compound.

In this case, as an Sn—Cu intermetallic compound is produced, the top-coating 4 is consumed and the Y value decreases. When the Sn—Cu intermetallic compound is Cu₆Sn₅, the thickness of the consumed top-coating 4 is about 1.9 times the thickness (X) of the intermediate coating 3.

Hence, in order to ensure that the top-coating remains, it is desirable to make the thickness of the top-coating 4 larger than 1.9X. Specifically, even when all the intermediate coating 3 disappears, if the thickness of the remaining top-coating 4 is 0.1 μm or larger, the plated material can maintain low contact resistance. Hence, it is desirable that the X value and the Y value should satisfy the relationship: Y≧1.9X+0.1.

However, when the thickness of the top-coating 4 after heat treatment is larger than 0.5 μm, the plated material produces very large friction when inserted or extracted and hence it is not suitable for practical use.

Hence, as requirement A, the X value and the Y value should satisfy the relationship:
1.9X+0.1≧Y≧1.9X+0.5 (1).

Requirement B: This is the requirement for the top-coating 4 not disappearing even when the plated material is placed in a high-temperature environment for a long time. Requirement B is determined considering the environment of practical use of the plated material according to the invention.

Whether the top-coating 4 will disappear or not while the plated material is used is influenced by the thickness (X) of the intermediate coating 3.

For example, when the thickness (X) of the intermediate coating 3 is small, also the layer 3′ of an Sn—Cu intermetallic compound formed in a heat treatment such as reflow treatment has a small thickness. Hence, Ni of the undercoating 2 passes through the layer 3′ and reacts with Sn of the top-coating 4. As a result, the top-coating 4 further decreases in thickness.

Thus, when the thickness (X) of the intermediate coating 3 is small, the thickness of the top-coating 4 needs to be made larger considering this diffusion of Ni of the undercoating.

In order to find requirement B, experiment (1) below was performed.

Electrolytic degreasing, pickling, Ni plating, Cu plating and Sn plating were performed on a base material of brass comprising 70 mass % Cu and 30 mass % Zn, in this order. The plating conditions here were as shown in Table 1 below.

TABLE 1

| | Plating conditions | | | | |
|---|---|---|---|---|---|
| | | | | Current | Plating |
| | | | Temperature | density | thickness |
| | Bath composition | | (° C.) | (A/dm²) | (μm) |
| Ni plating | Nickel sulfamate | 500 g/L | 50 | 20 | 0.5 |
| | Nickel chloride | 30 g/L | | | |
| | Boric acid | 30 g/L | | | |
| Cu plating | Copper sulfate | 250 g/L | 40 | 5˜20 | Changed by |
| | pentahydrate | | | | |
| | Salt | 20 g/L | | | changing |
| | | | | | plating time |
| Sn plating | Tin oxide (II) | 50 g/L | 25 | 5˜10 | 2.0 |
| | Methanesulfonic acid | 110 g/L | | | |
| | VTB-524M (product by | 30 g/L | | | |
| | Ishihara Chemical Co., Ltd.) | | | | |

On the obtained plated material, heat treatment was performed in the manner that reflow treatment was performed at a temperature 700° C. for 4 seconds and then the high temperature environment test was performed at a temperature 140° C. for 120 hours.

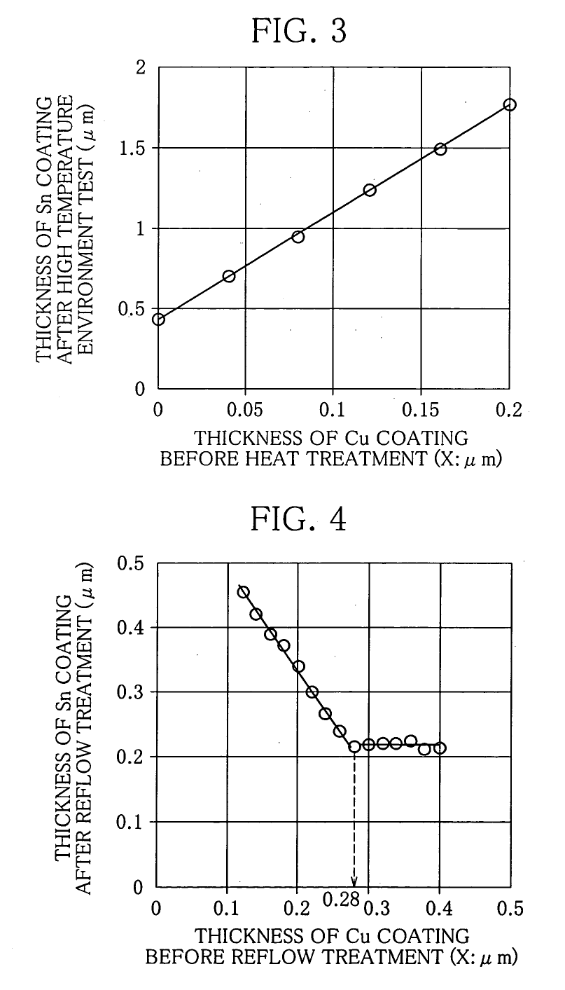

Regarding the plated material after this heat treatment, the thickness of the Sn top-coating was measured. The result is shown in FIG. 3 as a graph of the thickness of the Sn top-coating after high temperature environment test versus the thickness (X) of the Cu coating before heat treatment.

As is clear from FIG. 3, when the Cu coating was not formed (X=0), the thickness of the Sn coating decreased from 2 μm to 0.43 μm, which means that the Sn coating corresponding to the thickness 1.57 μm was consumed in inter-diffusion between the Sn coating and the Ni coating.

It is also clear from FIG. 3 that as the thickness (X) of the Cu coating increases, the thickness of the Sn top-coating remaining after the high temperature environment test increases linearly. The gradient of the line is 6.67. Hence, when a Cu coating of a certain thickness (X) is present before the heat treatment, of an Sn coating formed on the Cu coating, a part corresponding to the thickness 6.67X is not required for inter-diffusion.

From the above result of the experiment, it is found that in order to ensure that the Sn top-coating remains in practical use, the thickness of the Sn coating should be at least 1.57 μm if the Cu coating is not formed, and that when the Cu coating is formed the thickness corresponding to 6.67 times the thickness of the Cu coating is not required. Thus, the thickness (Y) of the Sn coating should be determined to satisfy the relationship:
Y≧−6.67X+1.57 (2).

Requirement C: This is the requirement for all the Cu coating being consumed for forming an Sn—Cu intermetallic compound in reflow treatment.

If the Cu coating remains after reflow treatment, it leads to the problems mentioned below. Thus, the requirement is for solving these problems.

A first problem is that if the Cu coating remains after reflow treatment, diffusion of Sn and Cu progresses in practical use, for example in a high-temperature environment, so that the Sn top-coating decreases in thickness. In order to compensate for the decrease in the thickness of the Sn coating, it is necessary to make the thickness (Y) of the Sn coating larger. However, this leads to deterioration in the insertablity/extractability (slidability) of the plated material.

A second problem is that the diffusion of Cu to Sn produces internal stress, which tends to let whiskers grow.

Thus, it is desirable that in reflow treatment, Cu should be completely consumed to form an Sn—Cu intermetallic compound.

In order to find this requirement, experiment (2) below was performed.

Plated materials were produced in the same way as in the above-described experiment (1), except that the plating thickness (Y) for the Sn coating was 0.7 μm and that the plating thickness (X) for the Cu coating was changed in the range of 0.2 to 0.5 μm.

After reflow treatment was performed on the obtained plated materials at a temperature 700° C. for 4 seconds, the thickness of the Sn top-coating was measured. The result is shown in FIG. 4 as a graph of the thickness of the Sn top-coating after reflow treatment versus the thickness (X) of the Cu coating before reflow treatment.

As is clear from FIG. 4, in the section where the thickness (X) of the Cu coating before reflow treatment is 0.28 μm or smaller, there is a leaner relationship between the X value and the thickness of the Sn coating after reflow treatment, and the gradient is −1.9.

This means that in reflow treatment, an intermetallic compound Sn₆Cu₅ is being formed from Sn and Cu, and hence Sn and Cu is being consumed.

In the section where the thickness (X) of the Cu coating before reflow treatment is larger than 0.28 μm, the thickness of the Sn coating after reflow treatment is fixed. This means that in reflow treatment, Sn has been all consumed and Cu remains.

Hence, requirement C to be satisfied is
X≧0.28 (3).

As already mentioned, the top-coating 4 is made of Sn or Sn alloy and provided to ensure that the plated material has good electrical contact property, corrosion resistance and solderability. If the top-coating 4 is made of Sn alloy, it is particularly desirable, because insertability/extractability is further improved.

Here, as the Sn alloy, for example, Sn alloys containing one or more metals chosen from Ag, Bi, Cu, In, Pb and Sb are desirable, because such Sn alloys have good solderability and do not let whiskers grow when formed into the top-coating.

It is to be noted that in view of the problem of Pb outflow to an environment, it is better to avoid the use of Sn alloys containing Pb, if possible.

Though the Sn alloy coating can be formed using the known alloy plating bath, it is preferable to form it in the following way, because the production cost can be much reduced.

After the undercoating and the intermediate coating are formed on the base, an Sn coating and a metal coating of one or more metals chosen from Ag, Bi, Cu, In, Pb and Sb are formed in this order. Here, in place of the Sn coating, an Sn alloy coating may be formed.

Next, reflow treatment or thermal diffusion treatment is performed on the entire coatings formed as above to cause selective thermal diffusion between a metal of the metal coating and Sn of the Sn coating (or Sn alloy coating) to turn them into an alloy. For example, in the case of reflow treatment, the treatment should be performed at an actual temperature of 230˜300° C. for 5 seconds or less. In the case of thermal diffusion treatment, the treatment should be performed at a temperature of 100˜120° C. for several hours. At such degrees of temperature, thermal diffusion hardly occurs between the other coatings.

It is to be noted that in the plated material according to the present invention, a coating of another material having a smaller thickness than those of the above-mentioned coatings may be formed between the base and the undercoating, between the undercoating and the intermediate coating, or between the intermediate coating and the top-coating. Further, the plated material may be in any shape such as the shape of a strip, a circular wire, a rectangular wire or the like.

### EXAMPLES

### Examples 1-24 According to the Present Invention, Comparison Examples 1-9

On a strip of brass that had received electrolytic degreasing and pickling, an undercoating, an intermediate coating and a top-coating were formed successively. In this way, various plated materials shown in Tables 3 and 4 were produced.

Conditions of plating performed for forming each coating are shown in Table 2.

TABLE 2

| | Composition of plating bath | | Bath | Current |
|---|---|---|---|---|
| Kind of | | Concentration | temperature | density |
| coating | Kind | (g/L) | (° C.) | (A/dm²) |
| Ni coating | Nickel sulfamate | 500 | 60 | 5 |
| | Boric acid | 30 | | |
| Co coating | Cobalt sulfate | 500 | 60 | 5 |
| | Boric acid | 30 | | |
| Ni-Co coating | Nickel sulfate | 200 | 60 | 5 |
| | Cobalt sulfate | 200 | | |
| | Boric acid | 30 | | |
| Ni-P coating | NYCO bath by KIZAI | — | 90 | Electroless |
| | Corporation | | | plating |
| Fe coating | Ferrous sulfate | 250 | 30 | 5 |
| | Ferrous chloride | 30 | | |
| | Ammonium chloride | 30 | | |
| Cu coating | Copper sulfate | 180 | 40 | 5 |
| | Sulfuric acid | 80 | | |
| Cu-Zn coating | Copper potassium cyanide | 50 | 25 | 1 |
| | Zinc potassium cyanide | 30 | | |
| | Potassium cyanide | 10 | | |
| Bright Cu | Cupracid bath by Atotech | — | 25 | 5 |
| Coating | Japan Co., Ltd. | | | |
| Bright Sn | FH50 bath by ISHIHARA | — | 30 | 5 |
| Coating | CHEMICAL CO., LTD. | | | |
| Sn Coating | 524M bath by ISHIHARA | — | 30 | 5 |
| | CHEMICAL CO., LTD. | | | |
| Bright Sn-Bi | 05M bath by ISHIHARA | — | 30 | 5 |
| coating | CHEMICAL CO., LTD. | | | |
| Bright Sn-Cu | HTC bath by ISHIHARA | — | 30 | 5 |
| coating | CHEMICAL CO., LTD. | | | |
| Bright Sn-Pb | FH30 bath by ISHIHARA | — | 30 | 5 |
| coating | CHEMICAL CO., LTD. | | | |
| Ag coating | Silver Potassium cyanide | 5 | 20 | 2 |
| | Potassium cyanide | 60 | | |
| Bi coating | Bismuth methanesulfonate | 50 | 20 | 5 |
| | Methanesulfonic acid | 150 | | |
| In coating | Indium sulfate | 50 | 20 | 1 |
| | Sodium sulfate | 40 | | |
| | Sodium tartrate | 200 | | |

Each produced plated material was heated to each temperature shown in Tables 3 and 4, and the thickness of the top-coating remaining at that time was measured in a manner specified below. Further, the apparent coefficient of dynamic friction of each plated material in an initial state was measured in a manner specified below.

The thickness of the remaining top-coating: After the plated material was set in an air bath of 100˜160° C. for 120 hours, the thickness of the remaining top-coating was measured by galvanostratic current dissolving method.

The apparent coefficient of dynamic friction: The apparent coefficient of dynamic friction was measured by Bowden friction test instrument on the conditions that the load was 294 mN, the sliding length was 10 mm, the sliding speed was 100 M/min, and the number of sliding actions was one. Here, a member used as a partner member was prepared as follows: A brass strip of 0.25 mm in board thickness was plated with Sn by reflow Sn plating so that the Sn coating might be of 1 μm in thickness, and then the strip was formed to have a bulge of 0.5 mmR.

The results are shown together in Tables 3 and 4.

TABLE 3

| | Coatings | | | | | | | | | | | | |
|---|---|---|---|---|---|---|---|---|---|---|---|---|---|
| | | | Intermediate | | | | Top-coating | | | | | | |
| | Undercoating | | coating | | Top-coating | | thickness/ | Thickness of remaining top-coating | | | | | Apparent |
| | | Thick- | | Thick- | | Thick- | Intermediate | (μm) | | | | | coefficient |
| | | ness | | ness | | ness | Coating | Heat treatment temperature (° C.) | | | | | of dynamic |
| | Kind | (μm) | Kind | (μm) | Kind | (μm) | thickness | Initial | 100 | 120 | 140 | 160 | friction |
| Example 1 | Ni coating | 0.5 | Cu coating | 0.1 | Bright Sn coating | 0.3 | 3 | 0.20 | 0.10 | 0.00 | 0.00 | 0.00 | 0.12 |
| Example 2 | Ni coating | 0.5 | Cu coating | 0.1 | Bright Sn coating | 0.6 | 6 | 0.50 | 0.37 | 0.20 | 0.05 | 0.00 | 0.15 |
| Example 3 | Ni coating | 0.5 | Cu coating | 0.2 | Bright Sn coating | 0.6 | 3 | 0.05 | 0.23 | 0.21 | 0.18 | 0.12 | 0.16 |
| Example 4 | Ni coating | 0.5 | Cu coating | 0.2 | Bright Sn coating | 1 | 5 | 0.90 | 0.62 | 0.60 | 0.59 | 0.43 | 0.21 |
| Example 5 | Ni coating | 0.5 | Cu coating | 0.3 | Bright Sn coating | 1 | 3.3 | 0.90 | 0.42 | 0.40 | 0.38 | 0.34 | 0.19 |
| Example 6 | Ni coating | 0.5 | Bright Cu | 0.3 | Bright Sn coating | 1 | 3.3 | 0.90 | 0.40 | 0.39 | 0.37 | 0.33 | 0.20 |
| | | | coating | | | | | | | | | | |
| Example 7 | Ni—P | 0.5 | Cu coating | 0.3 | Bright Sn coating | 1 | 3.3 | 0.90 | 0.41 | 0.41 | 0.39 | 0.35 | 0.19 |
| | coating | | | | | | | | | | | | |
| Example 8 | Co coating | 0.5 | Cu coating | 0.3 | Bright Sn coating | 1 | 3.3 | 0.90 | 0.42 | 0.41 | 0.39 | 0.34 | 0.20 |
| Example 9 | Ni—Co | 0.5 | Cu coating | 0.3 | Bright Sn coating | 1 | 3.3 | 0.90 | 0.43 | 0.41 | 0.39 | 0.35 | 0.19 |
| | coating | | | | | | | | | | | | |
| Example 10 | Fe coating | 0.5 | Cu coating | 0.3 | Bright Sn coating | 1 | 3.3 | 0.90 | 0.42 | 0.41 | 0.39 | 0.35 | 0.20 |
| Example 11 | Ni coating | 0.5 | Cu—Zn | 0.3 | Bright Sn coating | 1 | 3.3 | 0.88 | 0.39 | 0.37 | 0.36 | 0.30 | 0.20 |
| | | | coating | | | | | | | | | | |
| Example 12 | Ni coating | 0.5 | Cu coating | 0.2 | Sn coating → | 0.6 | 3 | 0.50 | 0.22 | 0.21 | 0.21 | 0.20 | 0.25 |
| | | | | | Reflow treatment | | | | | | | | |
| Example 13 | Ni coating | 0.5 | Cu coating | 0.04 | Bright Sn coating | 1 | 25 | 0.90 | 0.55 | 0.46 | 0.22 | 0.00 | 0.21 |
| Example 14 | Ni coating | 0.5 | Cu coating | 0.3 | Bright Sn coating | 0.6 | 2 | 0.50 | 0.12 | 0.10 | 0.02 | 0.00 | 0.16 |
| Example 15 | Ni coating | 0.5 | Cu coating | 0.3 | Bright Sn coating | 1.5 | 5 | 1.40 | 0.91 | 0.89 | 0.87 | 0.86 | 0.26 |
| Example 16 | Ni coating | 0.5 | Cu coating | 0.5 | Bright Sn coating | 1 | 2 | 0.90 | 0.31 | 0.10 | 0.09 | 0.08 | 0.19 |
| Example 17 | Ni coating | 0.5 | Cu coating | 0.5 | Bright Sn coating | 2 | 4 | 1.90 | 1.34 | 1.14 | 1.10 | 1.05 | 0.29 |

TABLE 4

| | Coatings | | | | | | | | | | | | |
|---|---|---|---|---|---|---|---|---|---|---|---|---|---|
| | | | | | | | Top- | | | | | | |
| | | | | | | | coating | | | | | | Apparent |
| | | | Intermediate | | | | thickness/ | | | | | | coeffi- |
| | Undercoating | | coating | | Top-coating | | Inter- | Thickness of remaining top-coating | | | | | cient |
| | | Thick- | | Thick- | | Thick- | mediate | (μm) | | | | | of |
| | | ness | | ness | | ness | coating | Heat treatment temperature (° C.) | | | | | dynamic |
| | Kind | (μm) | Kind | (μm) | Kind | (μm) | thickness | Initial | 100 | 120 | 140 | 160 | friction |
| Example 18 | Ni coating | 0.5 | Cu | 0.2 | Sn coating + | 1 | 5 | 0.75 | 0.62 | 0.42 | 0.21 | 0.13 | 0.14 |
| | | | coating | | Ag coating → | | | | | | | | |
| | | | | | Reflow treatment | | | | | | | | |
| Example 19 | Ni coating | 0.5 | Cu | 0.2 | Bright Sn—Bi coating | 1 | 5 | 0.89 | 0.42 | 0.24 | 0.00 | 0.00 | 0.13 |
| | | | coating | | | | | | | | | | |
| Example 20 | Ni coating | 0.5 | Cu | | Bright Sn—Bi coating | 1.5 | 7.5 | 1.39 | 0.89 | 0.60 | 0.00 | 0.00 | 0.16 |
| | | | coating | | | | | | | | | | |
| Example 21 | Ni coating | 0.5 | Cu | 0.2 | Sn coating + | 1.5 | 7.5 | 1.25 | 0.72 | 0.50 | 0.00 | 0.00 | 0.17 |
| | | | coating | | Ag coating → | | | | | | | | |
| | | | | | Reflow treatment | | | | | | | | |
| Example 22 | Ni coating | 0.5 | Cu | 0.2 | Bright Sn—Cu coating | 1 | 5 | 0.90 | 0.61 | 0.60 | 0.58 | 0.40 | 0.18 |
| | | | coating | | | | | | | | | | |
| Example 23 | Ni coating | 0.5 | Cu | 0.2 | Sn coating + | 1 | 5 | 0.75 | 0.44 | 0.43 | 0.00 | 0.00 | 0.22 |
| | | | coating | | In coating → | | | | | | | | |
| | | | | | Reflow treatment | | | | | | | | |
| Example 24 | Ni coating | 0.5 | Cu | 0.2 | Bright Sn—Pb coating | 1 | 5 | 0.90 | 0.55 | 0.53 | 0.50 | 0.21 | 0.19 |
| | | | coating | | | | | | | | | | |
| Comparison 1 | Ni coating | 0.5 | Cu | 0.5 | Bright Sn coating | 0.6 | 0.2 | 0.50 | 0.00 | 0.00 | 0.00 | 0.00 | 0.16 |
| | | | coating | | | | | | | | | | |
| Comparison 2 | Ni coating | 0.5 | — | — | Bright Sn coating | 1 | — | 0.93 | 0.58 | 0.37 | 0.03 | 0.00 | 0.19 |
| Comparison 3 | Ni coating | 0.5 | — | — | Bright Sn coating | 0.3 | — | 0.24 | 0.00 | 0.00 | 0.00 | 0.00 | 0.14 |
| Comparison 4 | — | — | Cu | 0.5 | Bright Sn coating | 0.3 | 0.6 | 0.20 | 0.00 | 0.00 | 0.00 | 0.00 | 0.13 |
| | | | coating | | | | | | | | | | |
| Comparison 5 | — | — | Cu | 0.5 | Bright Sn coating | 1 | 2 | 0.90 | 0.18 | 0.00 | 0.00 | 0.00 | 0.20 |
| | | | coating | | | | | | | | | | |
| Comparison 6 | — | — | Cu | 0.5 | Sn coating → | 1 | 2 | 0.65 | 0.48 | 0.29 | 0.08 | 0.00 | 0.38 |
| | | | coating | | Reflow treatment | | | | | | | | |
| Comparison 7 | — | — | Cu | 0.5 | Bright Sn—Bi coating | 1.5 | 3 | 1.38 | 0.00 | 0.00 | 0.00 | 0.00 | 0.21 |
| | | | coating | | | | | | | | | | |
| Comparison 8 | Ni coating | 0.5 | — | — | Bright Sn—Cu coating | 1.5 | — | 1.45 | 0.00 | 0.00 | 0.00 | 0.00 | 0.24 |
| Comparison 9 | Ni coating | 0.5 | — | — | Bright Sn—Pb coating | 1.5 | — | 1.44 | 0.00 | 0.00 | 0.00 | 0.00 | 0.25 |

The following is clear from Tables 3 and 4:

(1) When the Examples and the Comparison Examples are compared, it is found that in the Examples, generally, the top-coating (Sn) remains even when the environment temperature becomes high, and that the apparent coefficient of dynamic friction is small. Further, an Example having a top-coating formed with a larger thickness has a remaining top-coating (Sn) of a larger thickness after heating, therefore maintains heat-resistance, better. On the other hand, however, an Example having a top-coating of a smaller thickness has a smaller coefficient of dynamic friction. For this reason, an Example having a top-coating of a smaller thickness is advantageous in insertability/extractability.

(2) The similar effects are produced even in the case where the undercoating is not an Ni coating as in Examples 7˜10, if the undercoating is of a kind that prevents diffusion of a component of the substrate alloy (component of a substrate alloy such as Cu or Zn) toward the top-coating. Further, the similar effects are produced even in the case where the intermediate coating is made of Cu and the undercoating is not an Ni coating as in Examples 7˜10, if the rate of reaction between the intermediate coating and the undercoating is higher than the rate of reaction between the intermediate coating and the top-coating.

In the case where the thickness of the intermediate coating is small as in Example 13, the diffusion between the undercoating and the top-coating is restrained less. As is clear from comparison between Examples 14 and 15, when the top-coating has a larger thickness, the heat-resistance is higher, and when the top-coating has a smaller thickness, the apparent coefficient of dynamic friction is smaller, therefore the insertability/extractability is better.

### Examples 25˜33 According to the Present Invention, Comparison Examples 10˜25

Male and female terminals of 2.3 mm in tab width were made using samples of Examples 3, 5, 9 and 12 and Comparison Examples 5 and 6.

The male and female terminals were paired as shown in Table 5, and the paired male and female terminals were fitted together. Then, heat treatment was performed on the male and female terminals fitted together, at a temperature of 160° C. for 120 hours. Then, contact resistance between the male and female terminals was measured.

It is to be noted that when the male and female terminals were fitted together, insertion was performed at arate of 2 mm/sec, and the peak force required during the insertion was measured as force for insertion. The force for insertion shown in Table 5 is an average that was obtained from five samples.

Contact resistance was measured by joining the terminals with lead and making a current flow through them at 10 mA. The contact resistance shown in Table 5 is an average that was obtained from ten samples.

TABLE 5

| | | | Results | |
|---|---|---|---|---|
| | Material used for | Material used for | Force for | Contact resistance |
| | male terminal | female terminal | insertion (N) | (mΩ) |
| Example 25 | Example 3 | Example 3 | 5.3 | 1 |
| Example 26 | Example 3 | Example 5 | 5.5 | 0.9 |
| Example 27 | Example 3 | Example 12 | 5.6 | 0.9 |
| Comparison 10 | Example 3 | Comparison 5 | 5.8 | 3.5 |
| Comparison 11 | Example 3 | Comparison 6 | 6.2 | 2.3 |
| Example 28 | Example 5 | Example 3 | 5.9 | 0.9 |
| Example 29 | Example 5 | Example 5 | 6.0 | 0.6 |
| Example 30 | Example 5 | Example 12 | 6.2 | 0.6 |
| Comparison 12 | Example 5 | Comparison 5 | 6.3 | 4.2 |
| Comparison 13 | Example 5 | Comparison 6 | 6.6 | 3.7 |
| Example 31 | Example 12 | Example 3 | 6.2 | 1 |
| Example 32 | Example 12 | Example 5 | 6.3 | 0.5 |
| Example 33 | Example 12 | Example 12 | 6.5 | 0.6 |
| Comparison 14 | Example 12 | Comparison 5 | 7.4 | 3.2 |
| Comparison 15 | Example 12 | Comparison 6 | 6.9 | 2.9 |
| Comparison 16 | Comparison 5 | Example 3 | 6.5 | 8.4 |
| Comparison 17 | Comparison 5 | Example 5 | 6.7 | 5.3 |
| Comparison 18 | Comparison 5 | Example 12 | 6.8 | 5.1 |
| Comparison 19 | Comparison 5 | Comparison 5 | 6.9 | >10 |
| Comparison 20 | Comparison 5 | Comparison 6 | 7.2 | >10 |
| Comparison 21 | Comparison 6 | Example 3 | 7.1 | 7.4 |
| Comparison 22 | Comparison 6 | Example 5 | 7.1 | 4.2 |
| Comparison 23 | Comparison 6 | Example 12 | 7.3 | 3.5 |
| Comparison 24 | Comparison 6 | Comparison 5 | 7.3 | >10 |
| Comparison 25 | Comparison 6 | Comparison 6 | 7.6 | >10 |

The following is clear from Table 5:
(1) When the Examples and the Comparison Examples of terminal pair are compared, it is found that in the Examples, generally, force for insertion at the time of fitting is smaller, and contact resistance after heat treatment is smaller.

In the Examples of terminal pair, force for insertion at the time of fitting is generally small, specifically 5.3˜6.5N. In the Comparison Examples of terminal pair, force for insertion is smaller in the case where a male terminal is made using any of the Examples of plated material than in the case where a female terminal is made using any of the Examples of plated material. The reason is thought to be that when a male and a female terminals are fitted together, the female terminal comes in contact with the male terminal only at a point and therefore it is scraped only at one point, whereas the male terminal comes in contact with the female terminal linearly and therefore it is scraped linearly.

Thus, in order to reduce the force for insertion, it is thought to be effective to reduce the thickness of the top-coating Sn) of the male terminal.

The reason that the contact resistance after heat treatment is smaller in the Examples is thought to be that in the terminal pairs according to the present invention, the top-coating (Sn) remains even after heat treatment, which improves reliability of contact. In contrast, in the Comparison Examples, the top-coating (Sn) disappears due to heat treatment, which increases the contact resistance.

### Examples 34˜47 According to the Present Invention, Comparison Examples 26˜35

Using a strip of 7/3 brass, various plated materials were produced in the same way as Examples 1 to 24, and reflow treatment was performed on the obtained plated materials at a temperature 700° C. for 4 seconds.

Only, in all the plated materials, the undercoating 2 was Ni coating of 0.5 μm in thickness. The thickness (X) of the Cu intermediate coating 3 and the thickness (Y) of the Sn top-coating 4 were as shown in Table 6.

Regarding these materials, the apparent coefficient of dynamic friction was measured in the same way as Examples 1 to 24.

Further, from each of the materials, a piece regarded as a male terminal was made in the form of a flat plate just by cutting and a piece regarded as a female terminal was made by forming a bulge of 0.5 mm in radius. High temperature environment test was performed on both the male and female terminals in the atmosphere of a temperature 120° C. for 3000 hours. A 10 mA current was fed to flow through the male and female terminals in a stated that the flat plate and the bulge part were brought in contact by a load of 980 mN, and the contact resistance at the contact part was measured.

Further, from each of the plated materials after reflow treatment, male and female terminals of 2.3 mm in tab width were made. The male and female terminals were fitted together, where the peak force required during insertion was measured as an insertion resistance. Further, high temperature environment test was performed on the male and female terminals in the atmosphere of a temperature 120° C. for 3000 hours, and then the male and female terminals were fitted together and the contact resistance between the terminals was measured.

It is to be noted that when the male and female terminals were fitted together, insertion was always performed at a rate of 2 mm/sec.

The results are shown in Tables 6 and 7, where the measured value is an average value obtained from five times of measurement.

TABLE 6

| | | | Properties | | | |
|---|---|---|---|---|---|---|
| | | | | | | Contact |
| | Coating | | Apparent | | | resistance |
| | Thickness of Cu | Thickness of | coefficient | Contact | Insertion | between |
| | coating | Sn Coating | of dynamic | resistance | resistance | terminals |
| | (X: μm) | (Y: μm) | friction | (mΩ) | (peak: N) | (mΩ) |
| Example 34 | 0.26 | 1.05 | 0.33 | 1.1 | 4.6 | 0.5 |
| Example 35 | 0.34 | 1.05 | 0.32 | 0.8 | 4.5 | 0.8 |
| Example 36 | 0.40 | 1.05 | 0.31 | 1.2 | 4.4 | 0.4 |
| Example 37 | 0.14 | 0.90 | 0.30 | 1.6 | 4.0 | 0.6 |
| Example 38 | 0.20 | 0.90 | 0.29 | 1.2 | 3.8 | 0.7 |
| Example 39 | 0.26 | 0.90 | 0.27 | 0.9 | 3.6 | 0.7 |
| Example 40 | 0.34 | 0.90 | 0.25 | 2.2 | 3.5 | 0.5 |
| Example 41 | 0.40 | 0.90 | 0.24 | 2.1 | 3.4 | 1.0 |
| Example 42 | 0.14 | 0.75 | 0.24 | 3.1 | 3.4 | 0.9 |
| Example 43 | 0.20 | 0.75 | 0.25 | 1.9 | 3.3 | 0.9 |
| Example 44 | 0.26 | 0.75 | 0.25 | 2.9 | 3.2 | 0.4 |
| Example 45 | 0.34 | 0.75 | 0.22 | 15.9 | 3.1 | 7.0 |
| Example 46 | 0.40 | 0.75 | 0.23 | 12.8 | 3.2 | 19.0 |
| Example 47 | 0.20 | 0.60 | 0.25 | 1.0 | 2.7 | 1.3 |

TABLE 7

| | | | Properties | | | |
|---|---|---|---|---|---|---|
| | | | | | | Contant |
| | Coating | | Apparent | | | resistance |
| | Thickness of Cu | Thickness of | coefficient | Contact | Insertion | between |
| | coating | Sn Coating | of dynamic | resistance | resistance | terminals |
| | (X: μm) | (Y: μm) | friction | (mΩ) | (Peak: N) | (mΩ) |
| Comparison 26 | 0.20 | 1.20 | 0.45 | 0.4 | 6.3 | 0.4 |
| Comparison 27 | 0.34 | 1.20 | 0.40 | 0.6 | 5.6 | 0.5 |
| Comparison 28 | 0.10 | 1.05 | 0.42 | 12.3 | 5.9 | 8.9 |
| Comparison 29 | 0.20 | 1.05 | 0.39 | 0.7 | 5.5 | 0.4 |
| Comparison 30 | 0.10 | 0.90 | 0.34 | 71.0 | 4.5 | 10.0 |
| Comparison 31 | 0.10 | 0.75 | 0.27 | 54.9 | 3.8 | 28.3 |
| Comparison 32 | 0.10 | 0.60 | 0.23 | 98.8 | 3.1 | 39.1 |
| Comparison 33 | 0.14 | 0.60 | 0.21 | 39.3 | 3.0 | 59.6 |
| Comparison 34 | 0.26 | 0.60 | 0.22 | 28.3 | 2.9 | 8.1 |
| Comparison 35 | 0.34 | 0.60 | 0.18 | 19.5 | 2.5 | 12.5 |

The following is clear from Tables 6 and 7:

(1) When the Examples and the Comparison Examples are compared, it is found that in the Examples, generally, the resistance at the time of fitting is smaller, and the contact resistance after high temperature environment test is smaller.

In contrast, in some of the Comparison Examples, the resistance at the time of fitting is large, and in some of the Comparison Examples, the contact resistance after high temperature environment test is large.

(2) When Example 35 and Example 38 are compared, it is found they are close in the contact resistance after high temperature environment test but that Example 35 is larger in the apparent coefficient of dynamic friction before high temperature environment test and the insertion resistance.

This is because in Example 35, the thickness (X) of the Cu coating was larger, and hence the thickness (Y) of the Sn coating was made larger considering the remainder of the Cu coating after the reflow treatment. This applies also to the comparison between Example 36 and 39, Examples 40 and 43, and Examples 41 and 44.

If the thickness of the Cu coating is made so large that the Cu coating remains after reflow treatment, the Sn coating needs to be formed with a large thickness, correspondingly. This leads to deterioration in slidability (insertability/extractability) of the plated material.

### Example 48 According to the Present Invention, Comparison Examples 36 and 37

Base material of brass as used in Examples 1 to 24 was cut into pieces of 30 mm×20 mm. On the obtained pieces, electrolytic degreasing and pickling were performed, and then Ni plating, Cu plating and Sn plating were performed in this order under the conditions below to produce plated materials.
Ni plating: Bath composition: 500 g/L nickel sulfonate, 30 g/L nickel chloride, 30 g/L boric acid; Bath temperature: 50° C.; Current density: 20 A/dm²; Plating thickness: 0.5 μm in all of the Example and the Comparison Examples
Cu plating: Bath composition: 250 g/L copper sulfate pentahydrate, 20 g/L salt; Bath temperature: 40° C.; Current density: 5 to 20 A/dm²; Plating thickness: 0.24 μm in the Example and 0.31 μm in the Comparison Examples
Sn plating: Bath composition: 50 g/L tin oxide (II), 110 g/L methanesulfonic acid, 10 mL/L FH50A, 10 mL/L FH50B, 10 mL/L FH50C (the latter three are products by Ishihara Chemical Co., Ltd.); Plating thickness: 0.7 μm in all of the Example and the Comparison Examples

Then, heat treatment was performed as shown in Table 8. Then, the cross-sections of the obtained samples were observed with a scanning microscope, and the thickness of that part of the Cu coating which had not reacted with the Sn coating was measured in the samples.

Further, the samples were heated in the atmosphere of a temperature 50° C. for 240 hours. Then, the surfaces of the samples were observed with a opto-microscope (magnifying power: 20), and the number of produced whiskers of 20 μm or larger in length was counted.

The results are shown in Table 8 in a lump.

TABLE 8

| | | Thickness of the | |
|---|---|---|---|
| | | part of Cu | |
| | | coating which | |
| | | did not react | Number of |
| | | with Sn coating | produced |
| | Heating conditions | (μm) | whiskers |
| Example 48 | Reflow treatment at | 0 | 0 |
| | temperature | | |
| | 700° C. | | |
| | for 4 seconds | | |
| Comparison 36 | No heat treatment | 0.2 | 30 or more |
| Comparison 37 | At temperature | 0.07 | 3 |
| | 160° C. | | |
| | for 1.6 hours | | |

As is clear from Table 8, in the Example, the Cu coating completely disappeared in reflow treatment, and no whisker was produced. In contrast, in the Comparison Examples, the Cu coating remained after heat treatment and whiskers were produced.

This confirms that the remaining of the Cu coating correlates with the production of whiskers.

### INDUSTRIAL APPLICABILITY

As is clear from the above description, in the plated material according to the present invention, an intermediate coating of Cu or Cu alloy exists between an undercoating and a top-coating, and the thickness of the top-coating and the thickness of the intermediate coating are designed so that the top-coating of Sn or Sn alloy may remain even in a high temperature environment.

Therefore, the plated material has both high heat-resistance and good insertability/extractability, and therefore it is useful as a material for various electrical/electronic parts such as connectors, fitting-type connectors, contactors, etc. placed in a high temperature environment, for example, in an engine room of an automobile.

1. A method of producing a plated material, comprising the steps of:
forming an undercoating of any one of metals belonging to group 4, group 5, group 6, group 7, group 8, group 9 or group 10 of the periodic table or an alloy containing any one of those metals as a main component, an intermediate coating of Cu or a Cu alloy, and a top-coating of Sn or an Sn alloy on a surface of an electrically conductive base in this order, and
making the intermediate coating disappear and forming a layer virtually made of an Sn—Cu intermetallic compound.

2. The method of producing a plated material according to claim 1, wherein by heat treatment, the intermediate coating is made to disappear and the layer of virtually made of an Sn—Cu intermetallic compound is formed.

3. The method of producing a plated material according to claim 1, wherein by reflow treatment, the intermediate coating is made to disappear and the layer of virtually made of an Sn—Cu intermetallic compound is formed.

4. The method of producing a plated material according to any of claims 1 to 3, wherein the undercoating is virtually made of Ni.

5. The method of producing a plated material according to any of claims 1 to 4, wherein the thickness X (μm) of the intermediate coating and the thickness Y (μm) of the top-coating satisfy the relationship:
1.9X+0.1≧Y≧1.9X+0.5.

6. The method of producing a plated material according to any of claims 1 to 4, wherein the thickness X (μm) of the intermediate coating and the thickness Y (μm) of the top-coating satisfy the relationships:
1.9X+0.1≦Y≦1.9X+0.5,
−6.67X+1.57≦Y, and X≦0.28.

7. An electrical/electronic part using a plated material produced by the method according to any of claims 1 to 6.

8 The electrical/electronic part according to claim 7, wherein said electrical/electronic part is a fitting-type connector or a contactor.
